(19) United States
(12) Patent Application Publication
(10) Pub. No.: US 2018/0205300 A1
(43) Pub. Date: Jul. 19, 2018

(54) SLOT INSULATING PAPER AND STATOR OF ROTARY ELECTRIC MACHINE

(71) Applicant: HONDA MOTOR CO., LTD., Tokyo (JP)

(72) Inventors: Hidenori Okada, Utsunomiya-shi (JP); Takuya Fujimori, Kasama-shi (JP)

(21) Appl. No.: 15/873,043

(22) Filed: Jan. 17, 2018

(30) Foreign Application Priority Data
Jan. 19, 2017 (JP) 2017-007621

(51) Int. Cl. H02K 15/10; H01B 3/52; H02K 3/34

(52) U.S. Cl. CPC H02K 15/10; H02K 3/345; H01B 3/52

(57) ABSTRACT

Slot insulating paper is slot insulating paper inserted into a slot of a stator core of a rotary electric machine and configured to insulate the stator core and a coil arranged in the slot, the slot insulating paper including: an outer circumferential portion located outside the coil in a radial direction of the stator core. A recessed part which is recessed in a second side in an axial direction of the stator core when viewed from the radial direction and in which a recession of the recessed part is formed in a curved shape when viewed from the radial direction is formed in an edge on a first side of the outer circumferential portion in the axial direction thereof.

### CROSS-REFERENCE TO RELATED APPLICATION

Priority is claimed on Japanese Patent Application No. 2017-007621, filed Jan. 19, 2017, the content of which is incorporated herein by reference.

### BACKGROUND OF THE INVENTION

### Field of the Invention

The present invention relates to slot insulating paper and a stator of a rotary electric machine including the same.

### Description of Related Art

In the related art, as stators of rotary electric machines, there are stators including coils formed by joining a plurality of conductor segments to each other. The plurality of conductor segments are arranged in slots formed in stator cores in a circumferentially and radially aligned state. In such types of stators, conductor segments formed in a U shape are inserted into slots and then ends of the conductor segments protruding from stator cores are bent and are joined to ends of other conductor segments.

Also, slot insulating paper configured to insulate a stator core and a coil is arranged between an inner circumferential surface of a slot and the coil (for example, refer to Japanese Unexamined Patent Application Publication Nos. 2014-99999 and 2015-109738). The slot insulating paper is arranged to cover the entire circumference of the coil. The slot insulating paper is formed to be longer than the entire length of the slot in an axial direction of the stator core, and both ends thereof are arranged to project from the stator core.

However, since the slot insulating paper is arranged to project from the stator core, the slot insulating paper is bent together with a conductor segment when an end of the conductor segment protruding from the stator core is bent. For this reason, the slot insulating paper is damaged, such as being broken, and thus insulation between the stator core and the coil cannot be secured in some cases.

Thus, Japanese Unexamined Patent Application Publication No. 2014-99999 discloses a constitution in which the slot insulating paper is arranged such that a partial region of the slot insulating paper is a breakage resistant part which is more resistant to damage than other regions and the breakage resistant part is located at a slot end part.

Also, as another type of slot insulating paper, Japanese Unexamined Patent Application Publication No. 2015-109738 discloses slot insulating paper having a cutout formed in an extended portion projecting from the stator core and configured to prevent damage (breakage) in unintended parts.

### SUMMARY OF THE INVENTION

However, in the technique disclosed in Japanese Unexamined Patent Application Publication No. 2014-99999, it is necessary to cut the slot insulating paper from insulating paper in which a part serving as the breakage resistant part is provided in advance. For this reason, the costs of members are likely to increase as compared with when slot insulating paper is cut from general-purpose insulating paper.

In the technique disclosed in Japanese Unexamined Patent Application Publication No. 2015-109738, there are concerns about the concentration of the stress at a distal end of the cutout when a portion projecting from the stator core in the slot insulating paper is bent together with the conductor segment. The distal end of the cutout of the slot insulating paper is likely to be broken as a starting point when the stress is concentrated on the distal end of the cutout.

An objective of the present invention is to provide slot insulating paper capable of minimizing breakage while suppressing an increase in cost and a stator of a rotary electric machine including the slot insulating paper.

A first aspect of the present invention is slot insulating paper inserted into a slot of a stator core of a rotary electric machine and configured to insulate the stator core and a coil arranged in the slot, the slot insulating paper including: an outer circumferential portion located outside the coil in a radial direction of the stator core, wherein a recessed part recessed in a second side in an axial direction of the stator core when viewed from the radial direction is formed in an edge on a first side of the outer circumferential portion in the axial direction thereof, and a recession of the recessed part is formed in a curved shape when viewed from the radial direction.

A portion of the slot insulating paper projecting from the end surface facing the first side in the axial direction of the stator core is bent together with the coil when a portion of the coil arranged in the slot protruding from the stator core to the first side in the axial direction is bent. Thus, the tensile stress in the circumferential direction around the coil is generated in a portion of the slot insulating paper projecting from the end surface facing the first side in the axial direction of the stator core. Particularly, since an outer circumferential portion of the slot insulating paper located further outward than the coil in the radial direction of the stator core extends in the circumferential direction of the stator core, an edge of the outer circumferential portion generates stronger tensile stress than its periphery when the coil is bent in the circumferential direction of the stator core.

With the above-described constitution, the recessed part recessed in the second side in the axial direction of the stator core is formed in the edge on the first side in the outer circumferential portion of the slot insulating paper in the axial direction thereof. For this reason, a portion of the slot insulating paper projecting from the stator core more easily collapses in the circumferential direction than that of a constitution in which the edge of the outer circumferential portion extends in the circumferential direction. Moreover, since the length of the edge of the outer circumferential portion is longer than that of the constitution in which the edge of the outer circumferential portion extends in the circumferential direction and the recession is formed in the curved shape, the slot insulating paper can disperse the tensile stress generated in the edge of the outer circumferential portion over a wide range of the recessed part. Thus, it is possible to prevent the tensile stress from concentrating on a specific portion of the slot insulating paper and breaking the slot insulating paper. Slot insulating paper in which breakage is suppressed can be formed by forming a recessed part in the edge of the outer circumferential portion using general-purpose insulating paper. Therefore, slot insulating paper in which breakage is suppressed while an increase in manufacturing costs is minimized can be provided using general-purpose insulating paper.

According to a second aspect of the present invention, in the slot insulating paper according to the first aspect of the present invention, the length of the recessed part may be longer than the length of a circumference of a semicircle having a line segment connecting a first end part of the recessed part when viewed from the radial direction and a second end part of the recessed part when viewed from the radial direction as a diameter.

With the above-described constitution, the length of the recessed part is longer than that of the constitution in which the recessed part is formed in a circular arc shape of a semicircle. For this reason, the tensile stress generated in the edge of the outer circumferential portion can be dispersed over a wider range of the recessed part. Thus, it is possible to prevent the tensile stress from concentrating on a specific portion of the slot insulating paper and breaking the slot insulating paper.

According to a third aspect of the present invention, in the slot insulating paper according to the first or second aspect of the present invention, the recessed part may include: a pair of recessions; a bottom part extending in a straight line shape in a direction which is orthogonal to the axial direction when viewed from the radial direction; a first leg which is connected to a first side of the bottom part via a first of the recessions, which extends in a straight line shape, and in which an angle formed by the first leg and the bottom part is an obtuse angle; and a second leg which is connected to a second side of the bottom part via the second of the recessions, which extends in a straight line shape, and in which an angle formed by the second leg and the bottom part is an obtuse angle.

With the above-described constitution, since the angle formed by both sides of each recession is an obtuse angle, the tensile stress generated on the recessions can be reduced as compared with the constitution in which an angle formed by both sides of the recession is an acute angle. Thus, it is possible to prevent the tensile stress from concentrating on a specific portion of the slot insulating paper and breaking the slot insulating paper.

According to a fourth aspect of the present invention, slot insulating paper which is formed of one piece of insulating paper is inserted into a slot of a stator core of a rotary electric machine, and insulates the stator core and a coil arranged in the slot, wherein the slot insulating paper is arranged in a state in which a direction in which the tensile strength of the insulating paper is the highest is along a circumferential direction around the coil.

The tensile stress in the circumferential direction around the coil is generated in a portion of the slot insulating paper projecting from the end surface facing the first side in the axial direction of the stator core when a portion of the coil arranged in the slot protruding from the stator core to the first side in the axial direction is bent.

With the above-described constitution, the durability of the slot insulating paper when the coil is bent can be improved as compared with the slot insulating paper arranged in a state in which the direction in which the tensile strength of the insulating paper is the highest intersects the circumferential direction around the coil. Therefore, slot insulating paper capable of minimizing breakage while suppressing an increase in cost using general-purpose insulating paper can be provided.

According to a fifth aspect of the present invention, a stator of a rotary electric machine includes: the slot insulating paper according to any one of the first to fourth aspects; the stator core; and the coil.

With the above-described constitution, since the slot insulating paper in which the above-described actions and effects can be achieved is provided, a short-circuit between the stator core and the stator coil is prevented and thus the highly reliable stator of the rotary electric machine can be provided at a low cost.

### BRIEF DESCRIPTION OF THE DRAWINGS

FIG. 1 is a schematic constitution diagram (a cross-sectional view) showing an overall constitution of a rotary electric machine according to an embodiment.

FIG. 2 is a perspective view of a stator according to the embodiment.

FIG. 3 is a cross-sectional view showing a part of the stator according to the embodiment.

FIG. 4 is a perspective view of a coil segment group according to the embodiment.

FIG. 5 is a cross-sectional view taken along line V-V in FIG. 2.

FIG. 6 is a perspective view showing a part of the stator according to the embodiment.

FIG. 7 is a diagram showing a method for forming slot insulating paper.

FIG. 8 is a perspective view showing a part of a stator according to a first modified example of the embodiment.

FIG. 9 is a perspective view showing a part of a stator according to a second modified example of the embodiment.

FIG. 10 is a graph showing a relationship between the length of a first edge of slot insulating paper and tensile stress generated in the slot insulating paper.

### DETAILED DESCRIPTION OF THE INVENTION

An embodiment of the present invention will be described below on the basis of the drawings.

### Embodiment

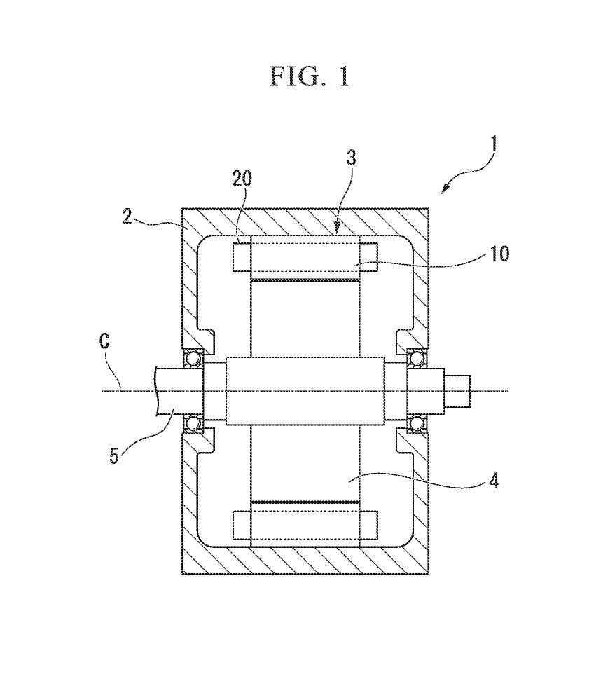

FIG. 1 is a schematic constitution diagram (a cross-sectional view) showing an overall constitution of a rotary electric machine according to an embodiment.

As shown in FIG. 1, a rotary electric machine 1 is, for example, a traveling motor mounted in a vehicle such as a hybrid vehicle or an electric vehicle. Here, the configuration of the present invention is not limited to a traveling motor and is also applicable to a power generation motor, motors for other purposes, or rotary electric machines not used in vehicles (including generators).

The rotary electric machine 1 includes a case 2, a stator 3, a rotor 4, an output shaft 5, and a refrigerant supply system (not shown).

The refrigerant supply system supplies a refrigerant to the stator 3, the rotor 4, or the like. Examples of the refrigerant include a hydraulic oil used for lubrication, power transmission, and the like in, for example, a transmission of an automatic transmission (AT). The rotary electric machine 1 is used in a state in which a part of the stator 3 is immersed in a refrigerant.

The output shaft 5 is rotatably supported by the case 2.

The rotor 4 is formed in a cylindrical shape externally fitted to the output shaft 5. Note that, in the following description, a direction along an axis C of the output shaft 5 is referred to as an axial direction, and a direction orthogonal to the axis C and radially extending from the axis C is referred to as a radial direction.

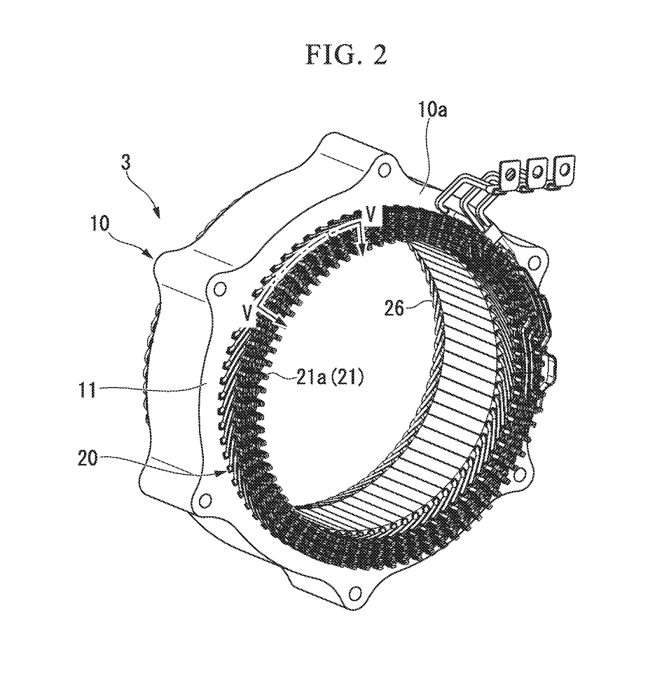

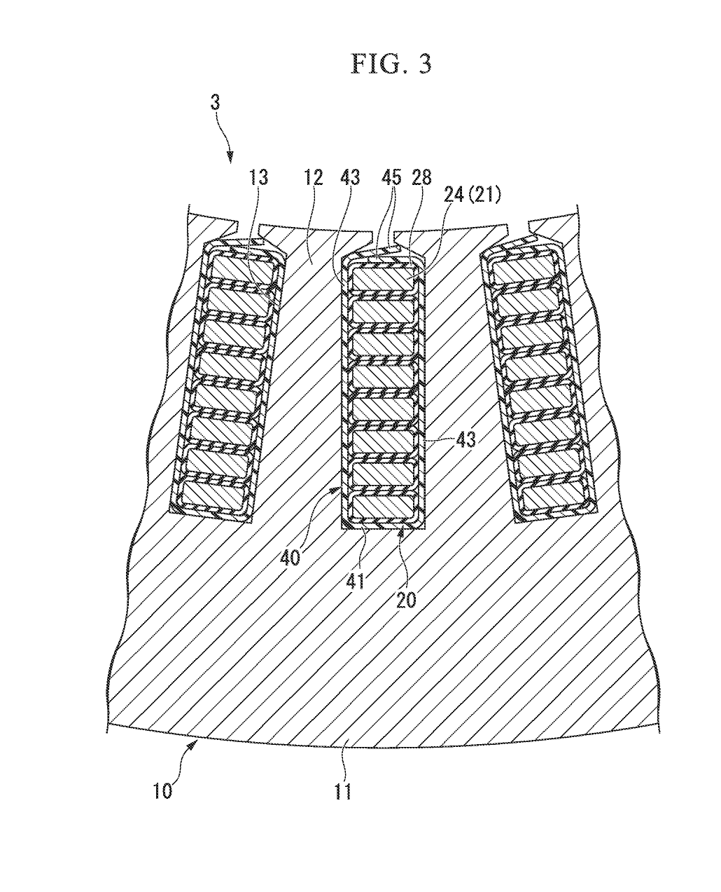

FIG. 2 is a perspective view of the stator according to the embodiment. FIG. 3 is a cross-sectional view showing a part of the stator according to the embodiment.

As shown in FIGS. 2 and 3, the stator 3 includes a stator core 10, stator coils 20 (coils) with a plurality of phases (for example, a U phase, a V phase, and a W phase) mounted in the stator core 10, and slot insulating paper 40 configured to insulate the stator core 10 and the stator coils 20.

The stator core 10 is formed in a cylindrical shape coaxial with the axis C. The stator core 10 surrounds the rotor 4 (refer to FIG. 1) from the outside in the radial direction. As shown in FIG. 3, the stator core 10 includes a cylindrical back yoke 11 and a plurality of teeth 12 protruding radially inward from an inner circumferential surface of the back yoke 11. Groove-shaped slots 13 are provided in the stator core 10. The slots 13 are provided between the teeth 12 adjacent to each other in a circumferential direction around the axis C. In other words, in the stator core 10, the teeth 12 and the slots 13 are alternately arranged in the circumferential direction around the axis C.

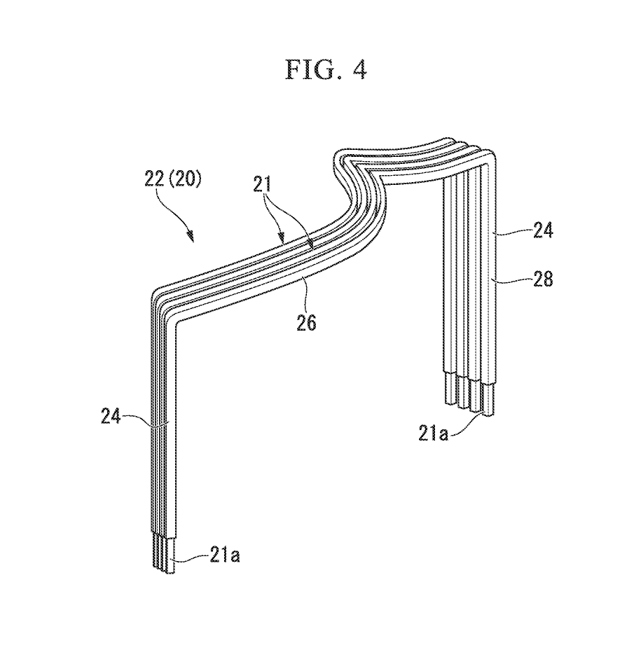

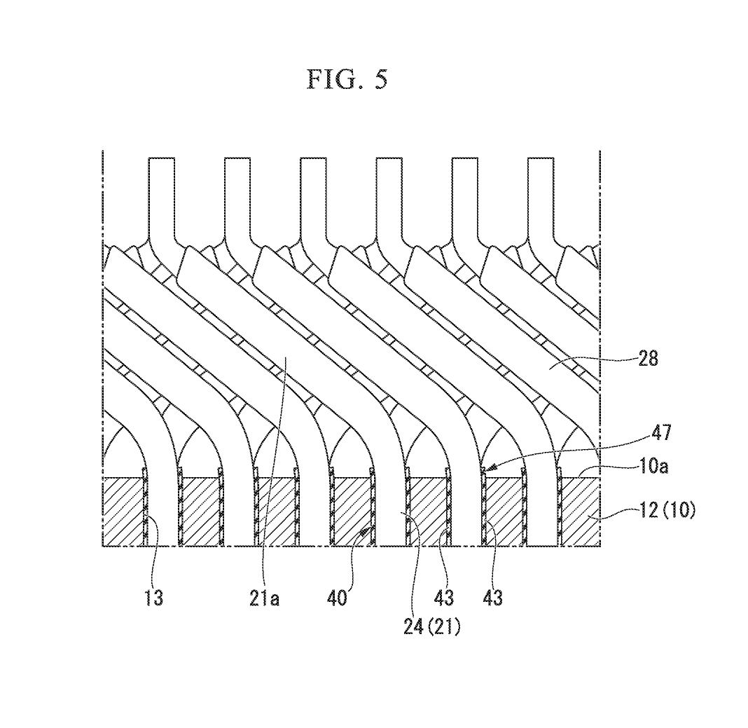

FIG. 4 is a perspective view of a coil segment group according to the embodiment. FIG. 5 is a cross-sectional view along line V-V in FIG. 2.

As shown in FIG. 4, each of the stator coils 20 includes a plurality of conductor segments 21 formed of rectangular wires having rectangular cross-sectional shapes. Each of the stator coils 20 is constituted of a plurality of coil segment groups 22 obtained by arranging a predetermined number of (four in the embodiment) conductor segment 21 as a bundle in the radial direction. As shown in FIGS. 4 and 5, each of the conductor segments 21 is formed in a U-shape by a pair of legs 24 extending parallel to each other and a curved coupling part 26 configured to couple the legs 24, and inserted into one of the slots 13. After that, each portions of the conductor segments 21 protruding from the slot 13 is bent. Each conductor segment 21 has a pair of ends 21a protruding from a first end of the stator core 10 toward a first side in the axial direction. Portions of the conductor segments 21 excluding distal ends of ends 21a thereof are insulated by an insulating coating film 28.

One of the legs 24 of each conductor segment 21 is inserted into a radially inner region in any of the slots 13. The other of the legs 24 is inserted into a radially outer region of a slot 13 which is a predetermined number of slots away from the slot 13 into which the one of the legs 24 is inserted. The pair of legs 24 of each conductor segment 21 extend in the axial direction inside the slots 13. Each of the legs 24 is arranged such that a pair of lateral surfaces having a wide width on each outer surface thereof face radially (refer to FIG. 3). The legs 24 of the conductor segments 21 inserted into the slots 13 have phases in an order of a U phase, a U phase, a V phase, a V phase, a W phase, and a W phase in the circumferential direction around the axis C.

As shown in FIG. 5, the ends 21a of the conductor segments 21 are bent in the circumferential direction around the axis C such that the bending directions of the conductor segments 21 adjacent to each other in the radial direction inside a slot 13 are opposite to each other and are in proximity to the ends 21a of a corresponding conductor segment 21 in phase. Adjacent ends 21a are joined together using tungsten inert-gas arc (TIG) welding, laser welding, or the like. Furthermore, powder coating is applied to the joined ends 21a with an insulating powder coating material (not shown). As shown in FIG. 2, the coupling parts 26 of the conductor segments 21 in the plurality of coil segment groups 22 are arranged at ends of the stator coils 20 on second sides in the axial direction such that the coupling parts 26 thereof continue in the circumferential direction around the axis C and the coupling parts 26 adjacent to each other in the circumferential direction around the axis C partly overlap when viewed from the axial direction.

As shown in FIG. 3, each piece of the slot insulating paper 40 is inserted into one of the slots 13. The slot insulating paper 40 is arranged between inner circumferential surfaces of the slots 13 and the stator coils 20. The slot insulating paper 40 is arranged to surround all of the conductor segments 21 in the slots 13 together. The slot insulating paper 40 is formed by bending rectangular insulating paper in accordance with an external form of the stator coils 20 in the slots 13. To be specific, the slot insulating paper 40 includes outer circumferential portions 41 located on the outer sides of the stator coils 20 in the radial direction, pairs of lateral portions 43 extending radially inward from ends of the outer circumferential portions 41 in the circumferential direction around the axis C, and pairs of inner circumferential portions 45 extending from a radially inner end of each of the lateral portions 43 toward the inside of the stator coil 20 in the radial direction. Folds are formed between the outer circumferential portions 41 and the lateral portions 43 and between the lateral portions 43 and the inner circumferential portions 45. The pairs of inner circumferential portions 45 are arranged to overlap in the radial direction.

As shown in FIG. 5, the slot insulating paper 40 is formed to be longer than the entire lengths of the slots 13 in the axial direction. The slot insulating paper 40 is inserted into the slots 13 such that ends thereof in the axial direction project from both end surfaces 10a of the stator core 10 in the axial direction. Hereinafter, parts of the slot insulating paper 40 projecting from the end surfaces 10a of the stator core 10 are referred to as projecting parts 47.

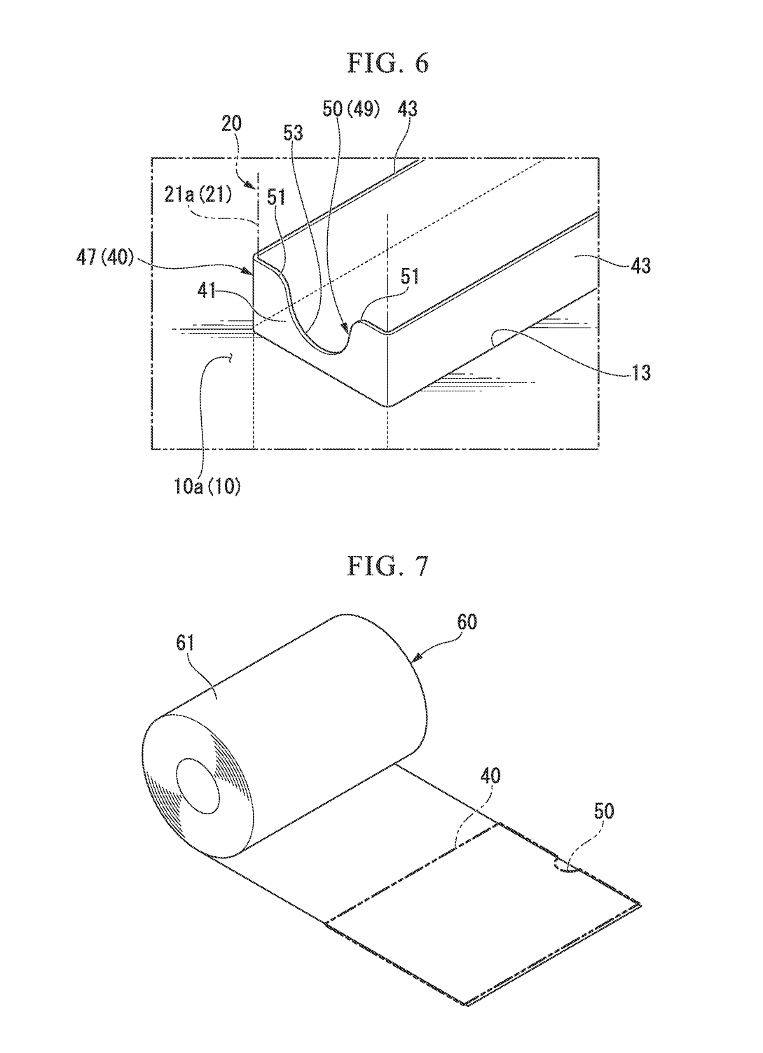

FIG. 6 is a perspective view showing a part of the stator according to the embodiment. Note that, in FIG. 6, the stator coil 20 is indicated by an alternate long and two short dashed line.

As shown in FIG. 6, a recessed part 50 recessed on a second side in the axial direction when viewed from the radial direction is formed in an edge 49 on a first side of the outer circumferential portion 41 in the axial direction (a side at which the end 21a of the conductor segment 21 is arranged). The recessed part 50 is formed only in a portion of the entire edge on a first side of the slot insulating paper 40 in the axial direction, which corresponds to the outer circumferential portion 41 (hereinafter referred to as a “first edge” of the slot insulating paper 40). A portion of the first edge of the slot insulating paper 40 other than the recessed part 50 extends in any direction which is orthogonal to the axial direction. The recessed part 50 is smoothly connected to the portion of the first edge of the slot insulating paper 40 other than the recessed part 50 when viewed from the radial direction.

The recessed part 50 has corners 51 and a recession 53 formed in a curved shape when viewed from the radial direction. To be specific, the recessed part 50 is formed of a pair of circular-arc-shaped corners 51 provided on both ends thereof and a semicircular-arc-shaped recession 53 provided between the pair of corners 51. A radius of curvature of the recession 53 is sufficiently larger than radii of curvature of the corners 51. A dimension of the recessed part 50 in the axial direction is smaller than a dimension of each of the projecting parts 47 in the axial direction. Thus, the inner circumferential surface of the slot 13 and the stator coil 20 are prevented from directly facing each other.

FIG. 7 is a diagram showing a method for forming slot insulating paper and is a perspective view of roll-shaped insulating paper.

The slot insulating paper 40 is formed by cutting it from one sheet of insulating paper. Insulating paper is, for example, paper made of a fibrous material, a resin film, a sheet obtained by stacking paper and a resin film, or the like. Generally, insulating paper is formed so that the tensile strength thereof is the highest in a predetermined direction in its surface. For example, insulating paper is supplied in a state in which it is wound in a roll shape as shown in FIG. 7, and the tensile strength is the highest in a circumferential direction of a roll body 60 of an insulating paper 61. In the embodiment, the slot insulating paper 40 is cut such that a direction in which the tensile strength of the insulating paper 61 is the highest (the circumferential direction of the roll body 60) is along a circumferential direction around the stator coil 20 inside the slot 13 as indicated by an alternate long and two short dashed line in FIG. 7, and arranged inside the slot 13. In other words, the slot insulating paper 40 is cut such that a direction which is orthogonal to a direction in which the tensile strength in the surface of the insulating paper 61 is the highest (a width direction of the strip-shaped insulating paper 61 in the example shown) is along the axial direction, and arranged inside the slot 13.

An action of the slot insulating paper 40 according to the embodiment will be described below.

As shown in FIGS. 5 and 6, the stator coil 20 is formed by inserting the conductor segment 21 into the slot 13 and then bending the end 21a of the conductor segment 21 protruding from the stator core 10 toward the first side in the axial direction in the circumferential direction around the axis C. The conductor segment 21 is bent using a portion opposite to an edge of the slot 13 as a fulcrum when the end 21a of the conductor segment 21 is bent in the circumferential direction around the axis C. For this reason, the projecting part 47 of the slot insulating paper 40 is bent together with the end 21a of the conductor segment 21. Thus, the tensile stress in the circumferential direction around the stator coil 20 is generated in the projecting part 47 of the slot insulating paper 40. Moreover, the plurality of conductor segments 21 inserted into the slots 13 are bent toward both sides in the circumferential direction around the axis C. For this reason, the outer circumferential portion 41 of the slot insulating paper 40 arranged in the circumferential direction around the axis C is pulled toward both sides in the circumferential direction around the axis C. As a result, the edge 49 of the outer circumferential portion 41 of the slot insulating paper 40 on the first side in the axial direction generates stronger tensile stress than its periphery.

In the slot insulating paper 40 according to the embodiment, the recessed part 50 recessed in a second side in the axial direction is formed in the edge 49 on the first side of the outer circumferential portion 41 in the axial direction. For this reason, the projecting part 47 around the axis C of the slot insulating paper 40 more easily collapses in the circumferential direction than that of a constitution in which an edge of the outer circumferential portion 41 extends in the circumferential direction around the axis C. Moreover, since the length of the edge 49 of the outer circumferential portion 41 is longer than that of the constitution in which the edge of the outer circumferential portion 41 extends in the circumferential direction around the axis C and the recession 53 is formed in a curved shape, the slot insulating paper 40 can disperse the tensile stress generated in the edge 49 of the outer circumferential portion 41 over a wide range of the recessed part 50. Thus, it is possible to prevent the tensile stress from concentrating on a specific portion of the slot insulating paper 40 and breaking the slot insulating paper 40. Since the recessed part 50 is formed in the edge 49 of the outer circumferential portion 41 using general-purpose insulating paper, the slot insulating paper 40 in which breakage is suppressed can be formed. Therefore, the slot insulating paper 40 in which breakage is limited while an increase in manufacturing costs is minimized can be provided using general-purpose insulating paper.

Note that the above-described length of the edge 49 is the length of the entire edge 49 in a plan view in a state in which the slot insulating paper 40 is developed in a sheet shape. The length of the recessed part in the following description is also the same as the length along a shape in a plan view including a straight line portion or a curved line portion.

Also, the slot insulating paper 40 is arranged in a state in which a direction in which the tensile strength in the insulating paper is the highest is along the circumferential direction around the stator coil 20. As described above, when the end 21a of the conductor segment 21 is bent, the tensile stress in the circumferential direction around the stator coil 20 is generated in the projecting part 47 of the slot insulating paper 40. For this reason, the durability of the slot insulating paper 40 when the conductor segment 21 is bent can be improved as compared with the slot insulating paper arranged in a state in which the direction in which the tensile strength in the insulating paper is the highest intersects the circumferential direction around the stator coil 20. Therefore, the slot insulating paper 40 in which breakage is suppressed while an increase in manufacturing costs is minimized can be provided using a general-purpose insulating paper.

Also, the stator 3 of the rotary electric machine 1 according to the embodiment includes the slot insulating paper 40 in which the above-described actions and effects can be achieved. For this reason, a short-circuit between the stator core 10 and the stator coil 20 is prevented and thus the highly reliable stator 3 can be provided at a low cost.

Modified examples of the recessed part of the slot insulating paper will be described below.

### First Modified Example of Embodiment

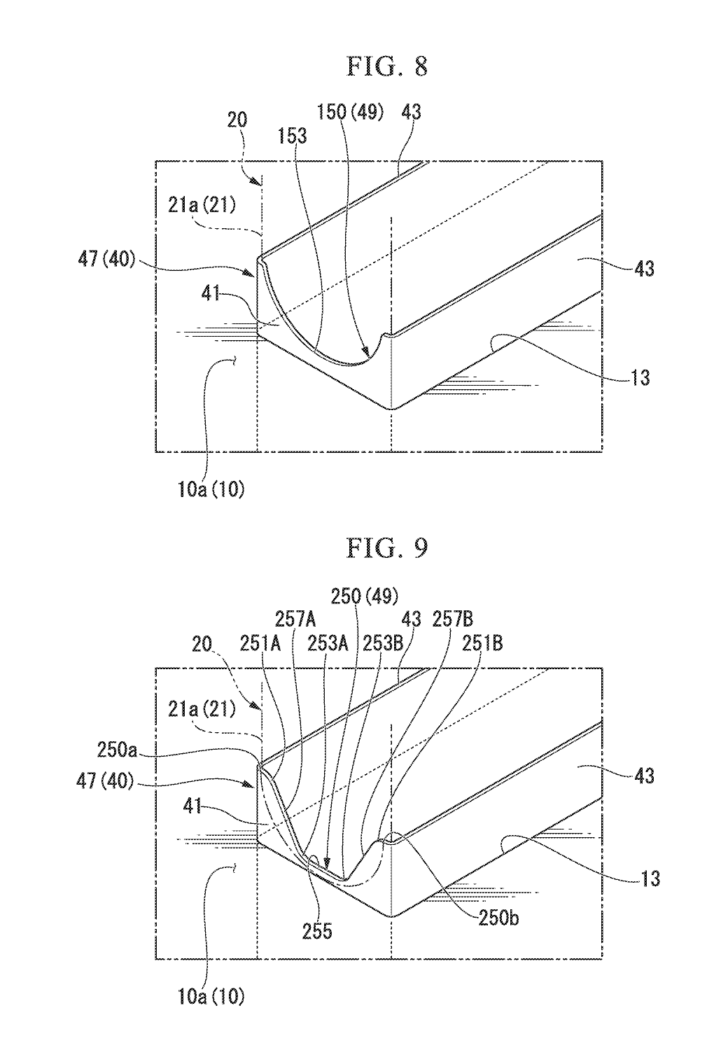

FIG. 8 is a perspective view showing a part of a stator according to a first modified example of the embodiment. Note that, in FIG. 8, a stator coil 20 is indicated by an alternate long and two short dashed line.

As shown in FIG. 8, a recessed part 150 is formed in a circular arc shape in which a radius of curvature thereof is larger than that of a recession 53 of a recessed part 50 according to the embodiment and a central angle thereof is smaller than 180 degrees when viewed from a radial direction. In other words, substantially the entire recessed part 150 is a recession 153. The length of the recessed part 150 is longer than the length of the recessed part 50 according to the above-described embodiment.

As described above, according to the modified example, since the recessed part 150 recessed in a second side in an axial direction in an outer circumferential portion 41 is formed in an edge 49 on a first side in the axial direction thereof, the same actions and effects as those of the above-described embodiment can be achieved.

Particularly, since substantially the entire recessed part 150 is the circular-arc-shaped recession 153 in the modified example, the tensile stress generated in the edge 49 of the outer circumferential portion 41 can be uniformly dispersed over a wide range of the recessed part 150. Thus, it is possible to prevent the tensile stress from concentrating on a specific portion of the slot insulating paper 40 to break the slot insulating paper 40.

### Second Modified Example of Embodiment

FIG. 9 is a perspective view showing a part of a stator according to a second modified example of the embodiment. Note that, in FIG. 9, a stator coil 20 is indicated by an alternate long and two short dashed line.

As shown in FIG. 9, a region surrounded by a recessed part 250 is formed in an isosceles shape when viewed from a radial direction. The recessed part 250 includes a pair of recessions 253A and 253B, a bottom part 255 provided between the pair of recessions 253A and 253B and extending in a straight line shape in a direction which is orthogonal to an axial direction when viewed from the radial direction, a first leg 257A connected to a first end of the bottom part 255 via the first recession 253A and extending in a straight line shape, a second leg 257B connected to a second end of the bottom part 255 via the second recession 253B and extending in a straight line shape, and a pair of corners 251A and 251B configured to connect the legs 257A and 257B and a portion of a first edge of a slot insulating paper 40 other than the recessed part 250. An angle formed by the first leg 257A and the bottom part 255 is an obtuse angle. An angle formed by the second leg 257B and the bottom part 255 is an obtuse angle.

The length of the recessed part 250 is longer than the length of a circumference of a semicircle (a semicircle indicated by an alternating single-dot-dash line in the drawing) having a line segment connecting a first end part 250a of the recessed part 250 when viewed from the radial direction and a second end part 250b of the recessed part 250 when viewed from the radial direction as a diameter. Furthermore, the length of the recessed part 250 is longer than the length of the recessed part 150 according to the first modified example of the embodiment.

As described above, according to the modified example, since the recessed part 250 recessed in a second side in an axial direction of an outer circumferential portion 41 is formed in an edge 49 on a first side in the axial direction thereof, the same actions and effects as those of the above-described embodiment can be achieved.

Also, the length of the recessed part 250 is longer than the length of the circumference of the semicircle having the line segment connecting the first end part 250a of the recessed part 250 when viewed from the radial direction and the second end part 250b of the recessed part 250 when viewed from the radial direction as the diameter. For this reason, since the length of the recessed part 250 is longer than that of a constitution in which a recessed part is formed in a circular arc shape of a semicircle, the tensile stress generated in the edge 49 of the outer circumferential portion 41 can be dispersed over a wider range of the recessed part 250. Thus, it is possible to prevent the tensile stress from concentrating on a specific portion of the slot insulating paper 40 and breaking the slot insulating paper 40.

Also, the recessed part 250 includes the bottom part 255 extending in a straight line shape, the first leg 257A which is connected to the first end of the bottom part 255, which extends in a straight line shape, and in which an angle formed by the first leg 257A and the bottom part 255 is an obtuse angle, and the second leg 257B which is connected to the second end of the bottom part 255, which extends in a straight line shape, and in which an angle formed by the second leg 257B and the bottom part 255 is an obtuse angle. Thus, since an angle formed by both sides of the first recession 253A between the bottom part 255 and the first leg 257A and an angle formed by both sides of the second recession 253B between the bottom part 255 and a second leg 255B are obtuse angles, it is possible to reduce the tensile stress generated at the recessions 253A and 253B as compared with that of a constitution in which an angle formed by both sides of the recession is an acute angle. Thus, it is possible to prevent the tensile stress from concentrating on a specific portion of the slot insulating paper 40 and breaking the slot insulating paper 40.

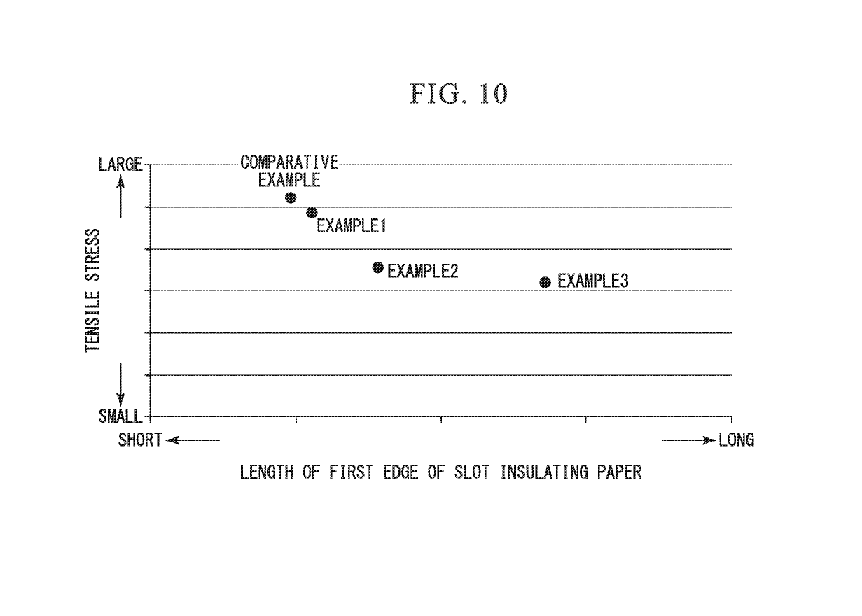

Here, FIG. 10 is a graph showing a relationship between the length of a first edge of slot insulating paper and a maximum value of the tensile stress generated in the slot insulating paper. Note that Example 1 in the drawing has the constitution of the above-described embodiment, Example 2 has the constitution of the first modified example of the above-described embodiment, and Example 3 has the constitution of the second modified example of the above-described embodiment. Furthermore, the comparative example in the drawing has a constitution in which a recessed part is not formed.

As shown in FIG. 10, as the length of the first edge of the slot insulating paper 40 is increased, the tensile stress generated in the slot insulating paper 40 decreases. In other words, as the length of the edge 49 of the outer circumferential portion 41 is increased by increasing the lengths of the recessed parts 50, 150, and 250, the tensile stress generated in the slot insulating paper 40 decreases. Thus, breakage of the slot insulating paper 40 can be prevented.

Note that the present invention is not limited to the above-described embodiment described with reference to the drawings, and various modified examples are conceivable in the technical scope thereof.

For example, although a case in which the first side in the axial direction is set to a side at which an end 21a of each conductor segment 21 is arranged has been described in the above-described embodiment, the first side in the axial direction may be set to a side at which a coupling part 26 of each conductor segment 21 is arranged. In other words, although the recessed parts 50, 150, and 250 are formed in a side at which an end 21a of each conductor segment 21 is arranged in the above-described embodiment, the recessed parts 50, 150, and 250 may be formed in an edge on a side at which a coupling part 26 of each conductor segment 21 is arranged. Furthermore, a recessed part may be formed in edges on both sides in the axial direction in the outer circumferential portion 41. Thus, it is possible to minimize breakage of the slot insulating paper 40 bent in accordance with a shape of the curved coupling part 26.

Also, although a corner and a recession of a recessed part are formed in a curved shape in the above-described embodiment, the present invention is not limited thereto. In addition, any recessed in which at least a recession is formed in a curved shape may be adopted.

Also, a shape of the recessed part is not limited to the shape shown in the above-described embodiment and its modified examples and can be formed in an arbitrary shape.

While preferred embodiments of the invention have been described and illustrated above, it should be understood that these are exemplary of the invention and are not to be considered as limiting. Additions, omissions, substitutions, and other modified examples can be made without departing from the spirit or scope of the present invention. Accordingly, the invention is not to be considered as being limited by the foregoing description, and is only limited by the scope of the appended claims.

What is claimed is:

1. Slot insulating paper inserted into a slot of a stator core of a rotary electric machine and configured to insulate the stator core and a coil arranged in the slot, the slot insulating paper comprising:
an outer circumferential portion located outside the coil in a radial direction of the stator core,
wherein a recessed part recessed in a second side in an axial direction of the stator core when viewed from the radial direction is formed in an edge on a first side of the outer circumferential portion in the axial direction thereof, and
a recession of the recessed part is formed in a curved shape when viewed from the radial direction.

2. The slot insulating paper according to claim 1, wherein a length of the recessed part is longer than a length of a circumference of a semicircle having a line segment connecting a first end part of the recessed part when viewed from the radial direction and a second end part of the recessed part when viewed from the radial direction as a diameter.

3. The slot insulating paper according to claim 1, wherein the recessed part includes:
a pair of recessions;
a bottom part extending in a straight line shape in a direction which is orthogonal to the axial direction when viewed from the radial direction;
a first leg which is connected to a first side of the bottom part via a first of the recessions, which extends in a straight line shape, and in which an angle formed by the first leg and the bottom part is an obtuse angle; and
a second leg which is connected to a second side of the bottom part via the second of the recessions, which extends in a straight line shape, and in which an angle formed by the second leg and the bottom part is an obtuse angle.

4. Slot insulating paper which is formed of one piece of insulating paper, is inserted into a slot of a stator core of a rotary electric machine, and insulates the stator core and a coil arranged in the slot, wherein the slot insulating paper is arranged in a state in which a direction in which the tensile strength of the insulating paper is the highest is along a circumferential direction around the coil.

5. A stator of a rotary electric machine comprising:
the slot insulating paper according to claim 1;
the stator core; and
the coil.

6. A stator of a rotary electric machine comprising:
the slot insulating paper according to claim 4;
the stator core; and
the coil.
